(19) United States
(12) Patent Application Publication
(10) Pub. No.: US 2012/0098880 A1
(43) Pub. Date: Apr. 26, 2012

(54) IMAGE FORMING APPARATUS, RECORDING MEDIUM CONVEYING APPARATUS, AND IMAGE FORMING METHOD

(75) Inventors: Takao Izumi, Kanagawa-ken (JP); Yoshiaki Kaneko, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/252,268

(22) Filed: Oct. 4, 2011

Related U.S. Application Data
(60) Provisional application No. 61/405,834, filed on Oct. 22, 2010.

(51) Int. Cl. B41J 29/38

(52) U.S. Cl. 347/16

(57) ABSTRACT

According to one embodiment, an image forming apparatus includes a conveying mechanism, a printing head, a charging device, a humidity sensor, and a controller. The conveying mechanism conveys a recording medium by adsorbing the medium using an electrostatic force. The printing head forms an image on the recording medium which is conveyed by the conveying mechanism. The charging device performs charging according to applied voltage, and adsorbs the recording medium using the electrostatic force, to the conveying mechanism. The humidity sensor detects the humidity in the apparatus. The controller determines voltage to be applied to the charging device in order to charge the charging device, on the basis of at least the humidity which is detected by the humidity sensor.

### CROSS-REFERENCE TO RELATED APPLICATIONS

This application is based upon and claims the benefit of priority from U.S. provisional application 61/405,834, filed on Oct. 22, 2010, the entire contents of which are incorporated herein by reference.

### FIELD

Embodiments described herein relate generally to an image forming apparatus, a recording medium conveying apparatus and an image forming method.

### BACKGROUND

In the related art, there is an image forming apparatus which holds a recording medium on the outer peripheral surface of a drum which rotates at a constant speed, conveys the recording medium by rotating the drum, and forms an image on the recording medium using printing heads which are provided on the outer peripheral portion of the drum.

As a method of holding the recording medium to the outer peripheral surface of the drum, for example, there is a method which electrostatically adsorbs the recording medium to the outer peripheral surface of the drum by applying an electrostatic charge to the surface of the drum, or to the recording medium.

When adopting such a method, there is a case where the recording medium is not reliably adsorbed to the outer peripheral surface of the drum, due to the state of the recording medium, or the influence of the temperature and the humidity of the inside of the image forming apparatus. If the adsorption force between the recording medium and the drum is weak, there is a problem in that an image forming position of the recording medium may deviate, or the recording medium may jam in the image forming apparatus.

### BRIEF DESCRIPTION OF THE DRAWINGS

FIG. 1 is a diagram which schematically shows a mechanism of an inkjet recording apparatus according to one embodiment.

FIG. 2 is a diagram which describes a configuration of a separating unit which is included in the recording apparatus.

FIG. 3 is a diagram for describing the configuration of the separating unit.

FIG. 4 is a block diagram which shows a system configuration of the recording apparatus.

FIG. 5 is a diagram for describing a configuration which is related to a correction of adsorption bias which is included in the recording apparatus.

FIG. 6 is a diagram which shows a circuit which is formed of a voltage and current output unit, a voltage and current detection unit, an adsorption roller, and a drum, which are included in the recording apparatus.

FIG. 7 is a diagram which shows a structure of a correction voltage table which is included in the recording apparatus.

FIG. 8 is a diagram which shows a coefficient table which is included in the recording apparatus.

FIG. 9 is a flowchart which shows an operation when the recording apparatus determines the adsorption bias in a case of a single-sided printing.

FIG. 10 is a flowchart for describing a specific example of the operation shown in FIG. 9.

FIG. 11 is a flowchart which shows an operation when the recording apparatus determines the adsorption bias in a case of a double-sided printing.

FIG. 12 is a flowchart for describing a specific example of the operation shown in FIG. 11.

FIG. 13 is a flowchart which shows an operation when the recording apparatus corrects the correction voltage table.

### DETAILED DESCRIPTION

In general, according to one embodiment, an image forming apparatus includes a conveying mechanism, a printing head, a charging device, a humidity sensor, and a controller.

The conveying mechanism adsorbs and conveys a recording medium using an electrostatic force. The printing head forms an image on the recording medium which is conveyed by the conveying mechanism. The charging device performs charging according to applied voltage, and adsorbs the recording medium using the electrostatic force to the conveying mechanism. The humidity sensor detects the humidity in the apparatus. The controller determines voltage to be applied to the charging device in order to charge the charging device, on the basis of at least the humidity which is detected by the humidity sensor.

Hereinafter, one embodiment will be described with reference to drawings.

In the embodiment, as an example of the image forming apparatus, an inkjet recording apparatus 1 is exemplified. Among a configuration of the inkjet recording apparatus 1, a recording medium conveying apparatus according to the embodiment is configured by a portion which is related to conveying of sheets P which are the recording medium.

### [Configuration of Inkjet Recording Apparatus 1]

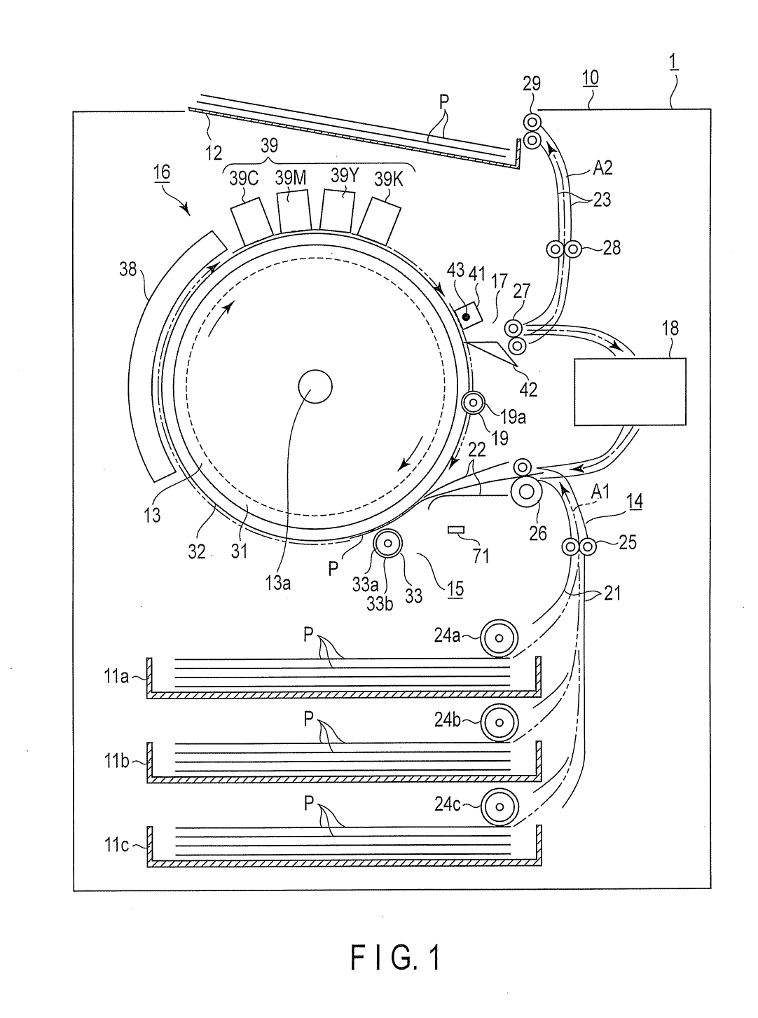

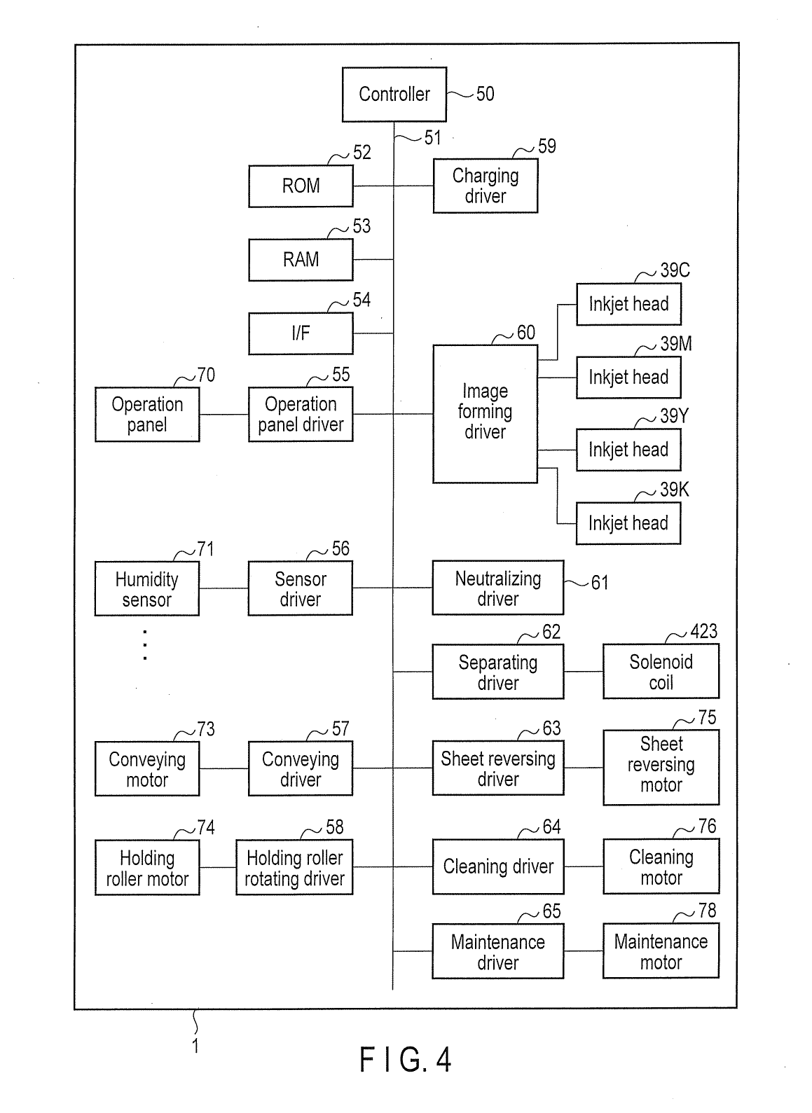

FIG. 1 schematically shows a mechanism of the inkjet recording apparatus 1, and FIG. 4 is a block diagram which shows a system configuration of the inkjet recording apparatus 1.

The inkjet recording apparatus 1 shown in FIG. 1 is a apparatus which performs a variety of processes, for example, such as image forming while conveying the sheet P. The inkjet recording apparatus 1 includes, a housing 10 which configures an outer frame; sheet feeding cassettes 11a, 11b, and 11c which are provided in the housing 10; a sheet discharge tray 12 which is provided on the top of the housing 10; an image forming unit 16 which forms images on the sheet P; a reversing device 18 which reverses the front surface and rear surface of the sheet P; a conveying device 14 which conveys the sheet P along a conveying path A1 from the sheet feeding cassette to a drum 13, and a conveying path A2 from the drum 13 to the sheet discharge tray 12; and a humidity sensor 71 which detects a humidity in the housing 10.

The conveying device 14 includes a plurality of guide members 21 to 23 which are provided along the conveying paths A1 and A2, and a plurality of conveying rollers which is provided along the conveying paths A1 and A2. As the conveying roller, pick-up rollers 24a, 24b, and 24c, a pair of sheet feeding rollers 25, a pair of resist rollers 26, a pair of separating rollers 27, a pair of conveying rollers 28 and a pair of discharge rollers 29 are provided.

In the embodiment, it is assumed that the sheet P which is accommodated in the sheet feeding cassette 11a is plain paper, the sheet P which is accommodated in the sheet feeding cassette 11b is thin paper thinner than the plain paper, and the sheet P which is accommodated in the sheet feeding cassette 11c is thick paper thicker than the plain paper. The sheets P which are accommodated in each of sheet feeding cassettes 11a, 11b, and 11c are picked-up along with rotation of the pick-up rollers 24a, 24b, and 24c, respectively, and are supplied to the conveying path A1.

The image forming unit 16 includes the drum 13 as a conveying mechanism which rotates while holding the sheet P on the outer peripheral surface thereof. The image forming unit 16 includes, a holding unit 15 which adsorbs and holds the sheet P while pressing the sheet onto the outer peripheral surface of the drum 13; a maintenance unit 38, an inkjet unit (printing heads) 39 which forms images on the sheet P which is held on the outer surface of the drum 13; a neutralizing and separating unit 17 which neutralizes the sheet P and separates it from the drum 13; and a cleaning unit 19 which cleans the drum 13, in addition to the drum 13. The holding unit 15, the maintenance unit 38, the inkjet unit 39, the neutralizing and separating unit 17, and the cleaning unit 19 are arranged in this order from the upstream side to the downstream side in a sheet P conveying direction along the outer peripheral surface of the drum 13, when setting a position where the guide member 22 and the drum 13 are approaching, as the starting point.

The drum 13 includes a rotation axis 13a, cylindrical frame 31 as a conductive part, which is formed of aluminum which is a conductor, and has a cylindrical shape, and a thin insulating layer 32 which is formed on the front surface of the cylindrical frame 31. The drum 13 has a cylindrical shape having a fixed length in the axial direction.

The holding unit 15 is a charging unit of a contact-type which includes an adsorption roller (a charging device) 33 which is formed of a chargeable member.

The adsorption roller 33 includes a charging axis 33a as a metal conductive part which extends in parallel to the rotation axis 13a, and can perform charging, and a surface layer portion 33b which is formed on the outer periphery of the charging axis 33a. The surface layer portion 33b of the adsorption roller 33 is formed of, for example, an insulating material which is elastically deformable such as a rubber material in order to prevent charge of charged sheet P from leaking through the adsorption roller 33.

If charge is supplied to the adsorption roller 33, the adsorption roller 33 performs charging. At this time, electrostatic charge is applied to the sheet P or the drum 13 from the adsorption roller 33, when the sheet P is conveyed between the adsorption roller 33 and the drum 13. The sheet P is adsorbed to the outer peripheral surface of the drum 13, due to the electrostatic force which is based on the electrostatic charge. In addition, in the embodiment, conveying is defined including that the sheet P is adsorbed to the drum 13, and passes through the same portions plural times due to the rotation of the drum 13.

The inkjet unit 39 includes a plurality of inkjet heads 39C, 39M, 39Y, and 39K of each color. The inkjet head 39C corresponds to cyan, the inkjet head 39M corresponds to magenta, the inkjet head 39Y corresponds to yellow, and the inkjet head 39K corresponds to black. Each of inkjet heads 39C, 39M, 39Y, and 39K are arranged to face the outer peripheral surface of the drum 13. Each of inkjet heads 39C, 39M, 39Y, and 39K ejects ink from nozzles which are arranged at a predetermined pitch, and forms images on the sheet P which is conveyed using the drum 13. In the embodiment, each ink is water-based ink.

The maintenance unit 38 moves to the inkjet head unit 39 at predetermined timing, and cleans a nozzle surface of each of inkjet heads 39C, 39M, 39Y, and 39K.

The neutralizing and separating unit 17 includes a neutralizing unit 41 which neutralizes the sheet P, and a separating unit 42 which separates the sheet P from the surface of the drum 13 after performing neutralization.

The neutralizing unit 41 includes a neutralizing roller 43 which is formed of a chargeable material. The neutralizing unit 41 releases an adsorption force by neutralizing the sheet P by supplying charge from the neutralizing roller 43, whereby the sheet P is in a state where it is easily separated from the drum 13.

The separating unit 42 is provided on the downstream side of the neutralizing unit 41 in the sheet P conveying direction, when setting the position where the guide member 22 and the drum 13 approach, as the starting point.

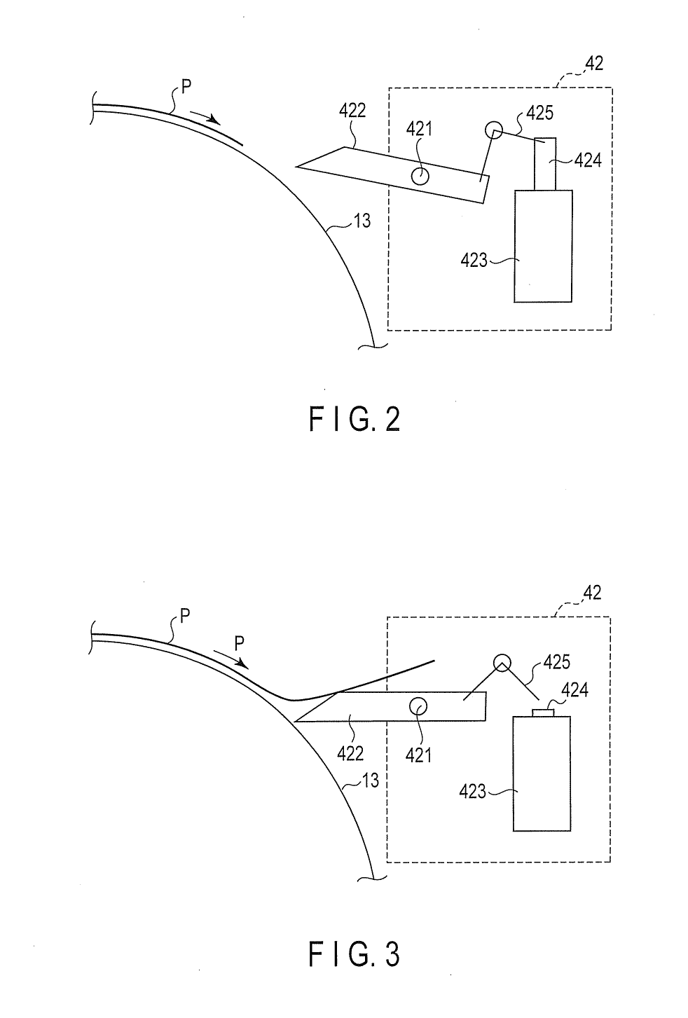

The specific configuration of the separating unit 42 will be described using the schematic diagram in FIGS. 2 and 3. The separating unit 42 includes, a separation claw 422 which is rotatably supported a rotation axis 421; a solenoid coil 423; a movable member 424 formed of metal which is inserted into the solenoid coil 423; and a transfer mechanism 425 which connects the upper portion of the movable member 424 and one end of the separation claw 422 to each other.

It is possible to allow the movable member 424 to protrude from the solenoid coil 423, or to be accommodated in the solenoid coil 423, by supplying or cutting off current to the solenoid coil 423.

In a state where the movable member 424 protrudes from the solenoid coil 423 as shown in FIG. 2, one end of the separation claw 422 is pressed downward through the transfer mechanism 425, and the other end of separation claw 422 stops at a position which is separated from the outer peripheral surface of the drum 13 with a distance which is sufficiently larger than the thickness of the sheet P. Accordingly, the sheet P which is conveyed using the drum 13, passes through a position of the separating unit 42 as is.

Meanwhile, in a state where the movable member 424 is accommodated in the solenoid coil 423 as shown in FIG. 3, the one end of the separation claw 422 is not pressed downward, and the other end of the separation claw 422 stops in a state where it comes into close contact with the outer peripheral surface of the drum 13. Accordingly, the sheet P which is conveyed using the drum 13 is separated from the drum 13 using the separation claw 422, and is supplied to the conveying path A2.

The cleaning unit 19 is provided on the downstream side of the neutralizing and separating unit 17, when setting a position where the guide member 22 and the drum 13 are approaching, as the starting point.

The reversing device 18 is provided between the conveying path A1 and the conveying path A2, reverses the front surface and rear surface of the sheet P which is separated in the separating unit 42, and supplies the sheet to the pair of resist rollers 26 again. As the reversing device 18, any type of a known mechanism may be used, for example, such as a switchable mechanism which can reverse the front and rear directions of the sheet P.

The humidity sensor 71 detects the relative humidity, which is the ratio of a water vapor pressure of air in the inkjet recording apparatus 1 and the saturated water vapor pressure of the air.

As shown in FIG. 4, the inkjet recording apparatus 1 includes a controller 50 which is configured by a CPU (Central Processing Unit), or the like. A ROM (Read Only Memory) 52, a RAM (Random Access Memory) 53, an interface (I/F) 54, an operation panel driver 55, a sensor driver 56, a conveying driver (a conveying driving control circuit) 57, a holding roller rotation driver 58, a charging driver (a charging driving control circuit) 59, an image forming driver 60, a neutralizing driver 61, a separating driver 62, a sheet reversing driver 63, a cleaning driver 64, and a maintenance driver 65 are connected to the controller 50 through a bus line 51 which is configured by an address bus and a data bus.

The ROM 52 stores fixed data such as a computer program which is executed by the controller 50. The computer program may be stored in another non-transitory storage medium, for example, a CD-ROM, and be provided to users. The RAM 53 is a main memory which forms various work memory areas, or temporarily stores image data. The interface 54 communicates with an external device through a communication cable, and performs inputting of data to the inkjet recording apparatus 1, or outputting data to the external device.

The operation panel driver 55 controls an operation panel 70 which is formed of a display with various operation buttons or a touch panel. The sensor driver 56 drives various sensors such as the humidity sensor 71, and obtains data which is detected from these sensors.

The conveying driver 57 drives a conveying motor 73 which rotates each roller 24 to 29. The holding roller rotation driver 58 drives a holding roller motor 74 which rotates the drum 13.

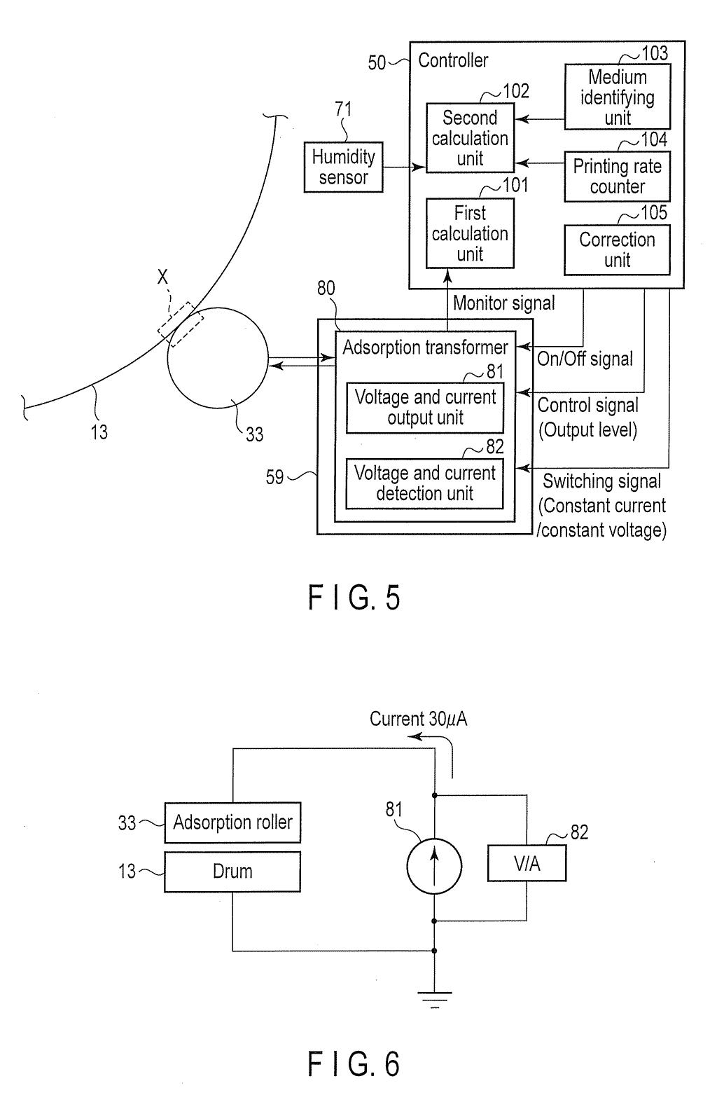

The charging driver 59 includes an adsorption transformer 80 shown in FIG. 5, and charges the adsorption roller 33. An operation of the adsorption transformer 80 will be described later.

The image forming driver 60 drives each of inkjet heads 39C, 39M, 39Y, and 39K. The neutralizing driver 61 connects to the neutralizing roller 43, and drives the neutralizing roller 43. The separating driver 62 turns on and off of power supplying to the solenoid coil 423, and moves the separation claw 422 as described using FIGS. 2 and 3.

The sheet reversing driver 63 drives a sheet reversing motor 75 which operates the reversing device 18. The cleaning driver 64 drives a cleaning motor 76 which operates the cleaning unit 19. The maintenance driver 65 drives a maintenance motor 78 which operates the maintenance unit 38.

### [Configuration Related to Correction of Adsorption Bias]

The magnitude of the electrostatic force which is generated between the drum 13 and the sheet P is determined by the voltage value (adsorption bias) which is applied to the adsorption roller 33. The electrostatic force weakens as the humidity in the inkjet recording apparatus 1 increases. In addition, since discharging occurs if the adsorption bias Vf is excessively large, it is not possible to obtain a suitable electrostatic force. Accordingly, it is necessary to set the adsorption bias to a suitable value which is neither too small nor too large.

The inkjet recording apparatus 1 according to the embodiment of the invention includes a function which corrects the adsorption bias to the optimal value.

A configuration which is related to the correction of the adsorption bias will be described using the block diagram in FIG. 5.

The controller 50 includes a first calculation unit 101, a second calculation unit 102, a medium identifying unit 103, a printing rate counter 104, and a correction unit 105. Each of units 101 to 105 are realized, for example, when the computer program which is stored in the ROM 52 is executed by the CPU.

The adsorption transformer 80 is included in the charging driver 59. The adsorption transformer 80 includes a voltage and current output unit 81 and a voltage and current detection unit 82.

A circuit diagram of a circuit which is formed of the voltage and current output unit 81, the voltage and current detection unit 82, the adsorption roller 33, and the drum 13, is shown in FIG. 6. The voltage and current output unit 81 applies arbitrary constant voltage or constant current to an adsorption position X. The adsorption position X is a position where the adsorption roller 33 and the drum 13 come into close contact therewith. In other words, it is a position where the adsorption roller 33 applies an electrostatic charge to the sheet P or the drum 13. The voltage and current detection unit 82 detects voltage or current which is generated in the voltage and current output unit 81.

The controller 50 outputs an on and off signal which turns on and off the supply of voltage or current from the voltage and current output unit 81, and a control signal which controls the output level of voltage or current which is supplied by the voltage and current output unit 81 and a switching signal which switches operation of the voltage and current output unit 81 to supply the constant current or the constant voltage to the adsorption transformer 80. It is possible for the controller 50 to output a constant voltage or a constant current of a desired level to the adsorption transformer 80, by selectively outputting these signals.

The adsorption transformer 80 outputs a monitor signal which denotes the voltage or current which is detected in the voltage and current detection unit 82 to the controller 50.

The medium identifying unit 103 identifies the type of the sheet P used in printing selected by the user, on the basis of input from the operation panel 70 or the interface 54, for example. However, identification of the sheet P may be performed on the basis of the identifier of the sheet feeding cassette which is selected by the user as a supplying source of the sheet P, and may be performed on the basis of an output of the sensor which detects the type of the sheet P which is conveyed through the conveying path A1 or the like. In addition, identification of the sheet P may be performed in such a manner that, for example, the sheet P is inserted between a pair of rollers, constant voltage is applied between the rollers, or constant current is allowed to flow, current or voltage which is generated between the rollers at that time, is detected, and identification is performed on the basis of the detected current or voltage. In this case, the pair of rollers may be the adsorption roller 33 or the drum 13. That is, the type of the sheet P is identified by outputting constant voltage or constant current from the voltage and current output unit 81, and using current or voltage which is detected at this moment in the voltage and current detection unit 82.

The printing rate counter 104 counts the number of dots which is formed on one sheet P, on the basis of a printing resolution which is designated by image data relating to a printing job, or an operation of the operation panel 70, and the printing rate R is obtained by dividing the count result by the total number of dots (numbers of line x numbers of row) which is included in one sheet P. In a case of double-sided printing, the printing rate counter 104 obtains the printing rate R for both the first surface which is the front surface of the sheet P and the second surface which is the rear surface.

The first calculation unit 101 obtains a first correction voltage Va in which a current which flows when applying to the adsorption roller 33 is supposed to be a predetermined target value, on the basis of a monitor voltage Vma which is detected using the voltage and current detection unit 82 when allowing the voltage and current output unit 81 to output constant current (30 μA in the embodiment), in a state where the sheet P is not present at the adsorption position X. The first correction voltage Va is a correction voltage which absorbs a change in the resistance value which occurs due to deterioration over time, or the like of the adsorption roller 33.

The second calculation unit 102 obtains a second correction voltage Vc, on the basis of humidity which is detected using the humidity sensor 71, the type of the sheet P which is identified by the medium identifying unit 103, and the printing rate R which is obtained by the printing rate counter 104. The humidity is taken into consideration because the amount of moisture contained in the sheet P differs depending on the humidity in the inkjet recording apparatus 1, the resistance value of the sheet P changes according to the amount of moisture, and the voltage which is necessary for the adsorption changes. The type of the sheet P is taken into consideration, because the resistance value is different according to the type of the sheet P, and the voltage which is necessary for the adsorption changes. The printing rate R is taken into consideration, because the resistance value of the sheet P changes depending on the attachment state of ink to the sheet P, and the voltage which is necessary for the adsorption changes. Particularly, when water-soluble ink is used, the resistance value of the sheet P remarkably changes.

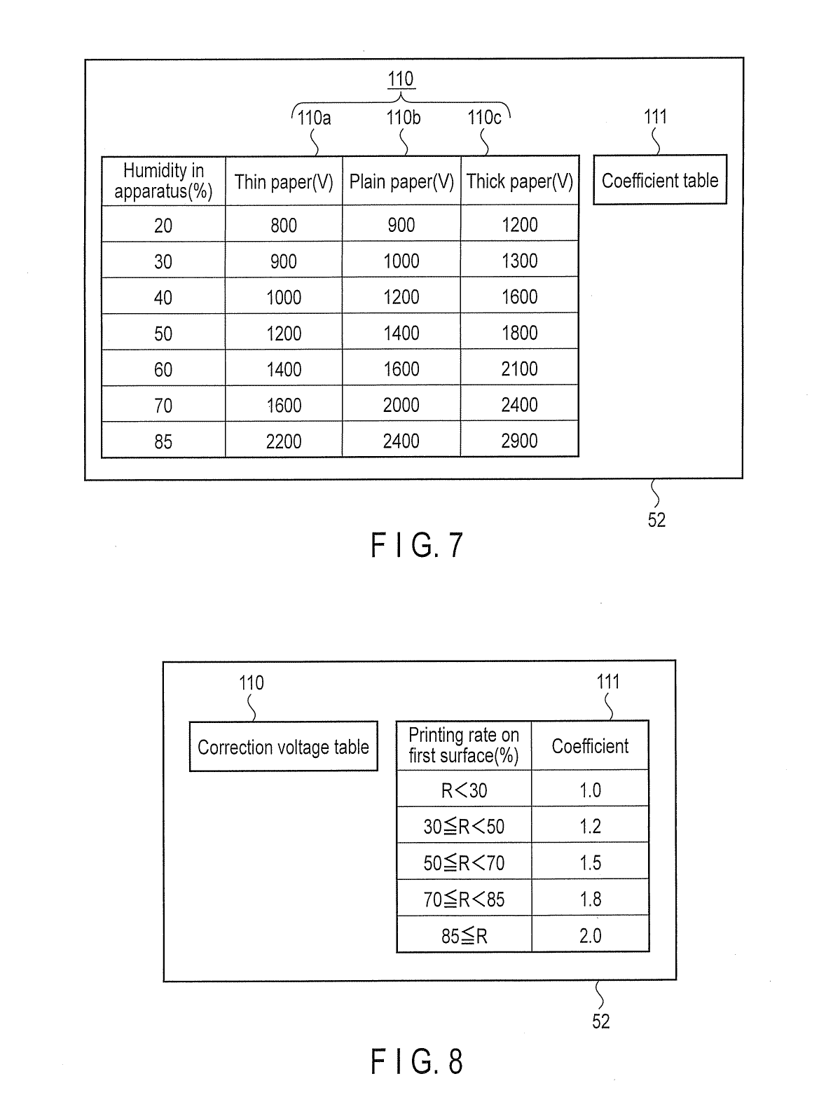

More specifically, the second calculation unit 102 obtains the second correction voltage Vc using a correction voltage table 110 shown in FIG. 7, and a coefficient table 111 shown in FIG. 8. These tables 110 and 111 are stored, for example, in the ROM 52 or the like.

The correction voltage table 110 is formed of a table 110a, 110b, and 110c for each type of the sheet P (thin paper, plain paper, thick paper). In each table 110a to 110c, the second correction voltage Vc is defined for each humidity in the inkjet recording apparatus 1. In other words, the second correction voltage Vc is defined with respect to a combination of the humidity and the type of the sheet P in the correction voltage table 110. The second correction voltage Vc which is defined in the correction voltage table 110 may be determined, for example, experimentally, empirically, and theoretically, such that the optimal adsorption bias is obtained by being added to the first correction voltage Va.

In the coefficient table 111, a coefficient for increasing and decreasing the second correction voltage Vc is defined for each range of the printing rate R of the first surface. In addition, in the shown example, a case where the printing rate R is less than 30% (R<30) is set to the reference value 1.0, and the coefficient increases from 1.0 as the printing rate R is high. However, for example, it may be preferable that when a printing rate R of 85% or more (85≦R) is set to the reference value 1.0, and the coefficient may decrease from 1.0 as the printing rate R decreases.

The correction unit 105 corrects the voltage which is defined in the correction voltage table 110 at a predetermined timing.

### [Basic Action of Inkjet Recording Apparatus 1]

The basic operation of the inkjet recording apparatus 1 with this configuration will be described.

When the execution of a printing job is instructed by the user through an operation of the operation panel 70 and inputting data from the interface 54, the controller 50 allows any one of the pick-up rollers 24a to 24c to rotate, and picks-up a sheet P of a type which corresponds to the instruction from any one of the sheet feeding cassette 11a to 11c, and supplies the sheet to the conveying path A1. Further, the controller 50 allows the pair of sheet feeding rollers 25 and the pair of resist rollers 26 to rotate, and supplies the sheet P which is supplied to the conveying path A1 to the outer peripheral surface of the drum 13.

Subsequently, the controller 50 allows the drum 13 to rotate, and allows the adsorption roller 33 to be charged. The sheet P is pressed onto the drum 13 by the charged adsorption roller 33, when passing through a nip which is formed between the adsorption roller 33 and the drum 13. At this moment, the electrostatic charge is applied to the drum 13 or the sheet P, and the sheet P is adsorbed to the outer peripheral surface of the drum 13 due to the electrostatic force. Thereafter, the sheet P is conveyed due to the rotation of the drum 13, and is supplied to an inkjet unit 39.

When a sensor provided in the inkjet unit 39 detects the leading end of the sheet P, after a predetermined time period the controller 50 drives each of inkjet heads 39C, 39M, 39Y and 39K, allows ink to be ejected, and forms a first image on the sheet P according to the image data to be printed. Thereafter, the controller 50 moves the inkjet unit 39 in a direction perpendicular to the conveying direction of the sheet P by a predetermined distance x. The sheet P on which the first image is formed rotates along with the drum 13, and is detected by the sensor which is provided in the inkjet unit 39 again. When the sensor detects the sheet P, the controller 50 drives each of inkjet heads 39C, 39M, 39Y and 39K after a predetermined time, allows ink to be ejected according to the image data to be printed, and forms a second image on the sheet P. Thereafter, the controller continuously performs the movement of the inkjet unit 39 by the distance x, and the ejection of ink by the necessary number of times n, as well. In this manner, an image in which images from the first image to an nth image are overlapped, is formed on the sheet P. For example, if a 150 dpi head is used as each of inkjet heads 39C, 39M, 39Y and 39K, a predetermined distance x is set to 42 μm (corresponding to one dot of 600 dpi), and the number of rotations n is set to 4, an image of 600 dpi is formed on the sheet P.

If the image of the nth number is formed, the controller 50 drives the neutralizing roller 43 and allows the separation claw 422 to come into close contact with the outer peripheral surface of the drum 13. At this moment, the sheet P which is conveyed along with the drum 13, is neutralized when passing through a position of the neutralizing roller 43, is separated from the drum 13 at the separation claw 422, is supplied to the conveying path A2, and is discharged to the sheet discharging tray 12 using the pair of conveying rollers 28 and the pair of discharging rollers 29.

In addition, when a double-sided printing is instructed, the sheet P which is separated from the drum 13 at the separation claw 422 is sent to the reversing device 18, and is sent to the nip of the pair of resist rollers 26 again, after being reversed back to front. The same process is performed for the printing with respect to the reversed sheet P.

### [Correction of Adsorption Bias]

A specific process relating to a correction of adsorption bias will be described. The contents of the process are different in a case of a single-sided printing and a double-sided printing.

First, a case of the single-sided printing will be described.

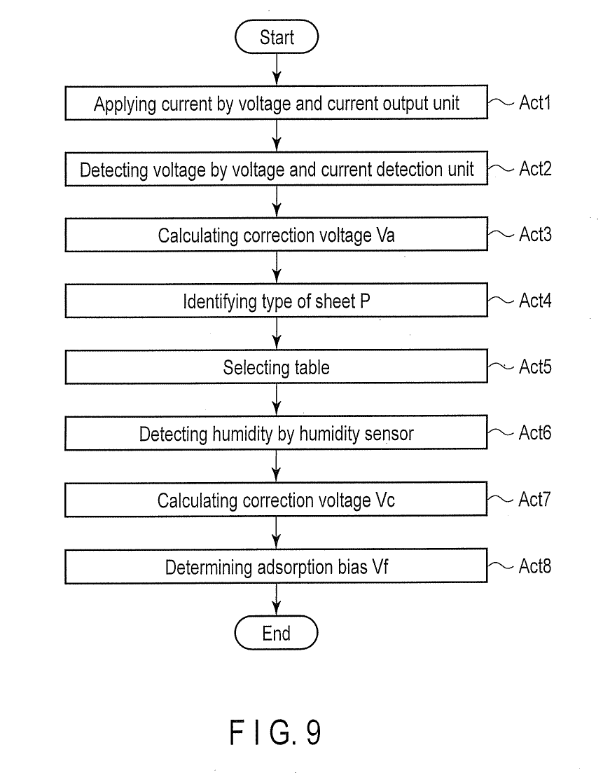

When an execution of a printing job is instructed by the user, the adsorption bias to be applied to the adsorption rollers 33 is to be determined in this job, so a process shown in the flowchart in FIG. 9, is executed.

In a first stage of the process, first, the controller 50 outputs an on-signal, a control signal which denotes a predetermined level (30 μA in the embodiment), and a switching signal to a constant current, to the adsorption transformer 80, in a state in which the sheet P is not present at the adsorption position X. When receiving these signals, the voltage and current output unit 81 outputs constant current of 30 μA to the adsorption roller 33 (Act 1). In addition, the voltage and current detection unit 82 detects voltage which is generated in the voltage and current output unit 81, that is, the voltage which is generated at the adsorption position X (Act 2). The detected voltage is informed to the controller 50 by a monitor signal. The controller 50 obtains monitor voltage Vma, on the basis of the monitor signal.

Subsequently, based on the monitor voltage Vma, the first calculation unit 101 obtains the first correction voltage Va in which current which flows when being applied to the adsorption roller 33, is supposed to be a predetermined target value (Act 3). The target value of the current is set to a value such that a good electrostatic force is obtained for adsorbing the sheet P onto the drum 13, when the current with the target value is allowed to flow in the adsorption roller 33, for example, when the humidity is sufficiently low. Further, the first calculation unit 101 may obtain the first correction voltage Va corresponding to the monitor voltage Vma, for example, by storing a table which defines a relationship between the monitor voltage Vma and the first correction voltage Va in the ROM 52, and referring to the table.

In addition, the first calculation unit may obtain the first correction voltage Va in which the current which flows when being applied to the adsorption roller 33, is supposed to be the target value, on the basis of monitor current Ima which is detected using the voltage and current detection unit 82, when the voltage and current output unit 81 is allowed to output the constant voltage, in a state in which the sheet P is not present at the adsorption position X.

After the first correction voltage Va is obtained, a type of the sheet P which the medium identifying unit 103 uses in the printing job, is identified (Act 4). Thereafter, the second calculation unit 102 selects a table which corresponds to the type of the sheet P which is identified using the medium identifying unit 103, from tables 110a to 110c which constitute the correction voltage table 110 (Act 5).

Further, the controller 50 drives the humidity sensor 71, so as to detect humidity in the inkjet recording apparatus 1 (Act 6).

Subsequently, the second calculation unit 102 obtains a second correction voltage Vc, on the basis of the humidity which is detected using the humidity sensor 71 (Act 7). More specifically, the second calculation unit 102 sets voltage which corresponds to the humidity detected using the humidity sensor 71, to the second correction voltage Vc in the table selected at Act 5.

Finally, the controller 50 determines an adsorption bias Vf, on the basis of the first correction voltage Va which is obtained by the first calculation unit 101 and the second correction voltage Vc which is obtained by the second calculation unit 102 (Act 8). In the embodiment, a value in which the first correction voltage Va and the second correction voltage Vc are added, is set to the adsorption bias Vf. In this case, the target value of the current or the voltage which is defined in the correction voltage table 110, may be determined such that the optimal adsorption bias Vf is obtained by adding the first correction voltage Va and the second correction voltage Vc.

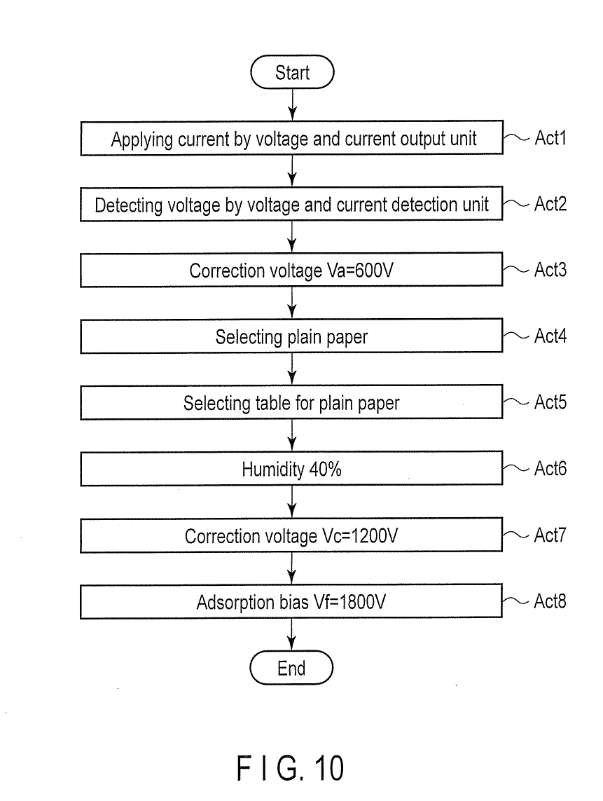

Specific examples of the Act 1 to Act 8 will be described using the flowchart in FIG. 10.

It is supposed that the first correction voltage Va obtained in Act 3 through Acts 1 and 2, is 600 V, and a type of the sheet P which is identified using the medium identifying unit 103 in Act 4, is “plain paper”. At this time, the second calculation unit 102 selects the table 110b which corresponds to the “plain paper”, in Act 5.

Further, if the humidity detected using the humidity sensor 71 in Act 6 is set to 40%, the second correction voltage Vc which is obtained by the second calculation unit 102 in Act 7, becomes 1200 V. Accordingly, the adsorption bias Vf which is determined by the controller 50 in Act 8, becomes 1800 V (600 V+1200 V).

After performing operations of Act 1 to Act 8, the controller 50 outputs an on-signal, a control signal which denotes a level corresponding to the adsorption bias Vf, and a switching signal to the constant current, to the adsorption transformer 80. At this moment, the adsorption bias Vf is applied to the adsorption roller 33 using the voltage and current output unit 81, and the adsorption roller 33 is charged. In this state, the controller 50 rotates the drum 13, applies electrostatic charge to the sheet P which passes through the nip formed between the adsorption roller 33 and the drum 13, and adsorbs the sheet P onto the outer peripheral surface of the drum 13 due to electrostatic force. Thereafter, the sheet P is conveyed using the rotation of the drum 13, and the inkjet unit 39 forms an image on the sheet P.

When the printing job is printing for plural pages, the printing for each page is performed using the adsorption bias Vf.

Subsequently, a case of double-sided printing will be described.

In the case of the double-sided printing, adsorption bias which is applied to the adsorption roller 33 when printing a first surface of the sheet P and adsorption bias which is applied to the adsorption roller 33 when printing a second surface of the sheet P, are respectively obtained. The adsorption bias for printing the first surface is defined as Vf1, and the adsorption bias for printing the second surface is defined as Vf2.

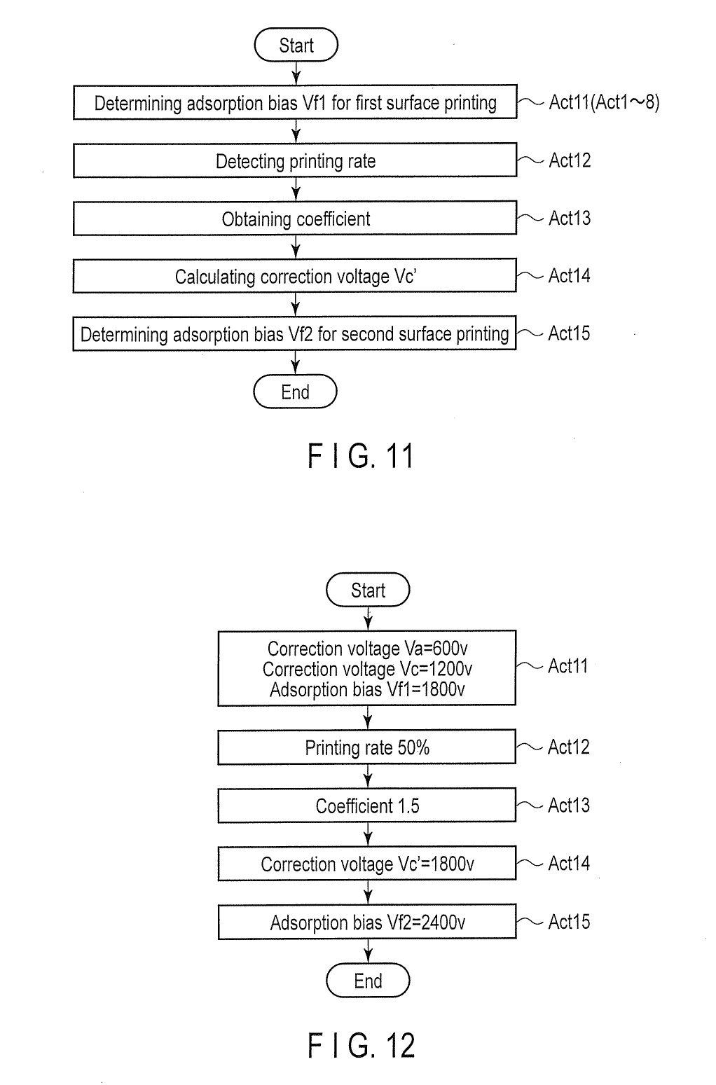

When an execution of a printing job relating to double-sided printing is instructed by the user, it is supposed to determine the adsorption bias Vf1 and adsorption bias Vf2 to be applied to the adsorption roller 33 in the job, and processing which is shown in the flowchart in FIG. 11, is executed.

In this flowchart, first, the adsorption bias Vf1 for printing the first surface is determined in the flow of the above described Acts 1 to 8 (Act 11).

Subsequently, the printing rate counter 104 detects a printing rate R on the first surface (Act 12). Thereafter, the second calculation unit 102 obtains a coefficient corresponding to the printing rate R on the first surface from the coefficient table 111 (Act 13).

The second calculation unit 102 multiplies the second correction voltage Vc obtained when determining the adsorption bias Vf1 in Act 11 (more specifically in Act 7), by the coefficient obtained in Act 13, thereby obtaining a second correction voltage Vc′ (Act 14). Further, the second calculation unit 102 determines the adsorption bias Vf2 by adding the first correction voltage Va and the second correction voltage Vc′ which are obtained when determining the adsorption bias Vf1 in Act 11 (more specifically in Act 3) (Act 15).

Specific examples of Acts 11 to 15 will be described using the flowchart in FIG. 12.

Similarly to the case in FIG. 10, it is supposed that the first correction voltage Va which is obtained in Act 11 (in Acts 1 to 8) is 600 V, the second correction voltage Vc is 1200 V, and the adsorption bias Vf1 is 1800 V.

Further, it is supposed that a printing rate R which is obtained by the printing rate counter 104 in Act 12, is 50%.

In this case, a coefficient which is obtained from the coefficient table 111 by the second calculation unit 102 in Act 13 becomes “1.5”. Accordingly, the second correction voltage Vc′ which is obtained by the second calculation unit 102 in Act 14, becomes 1800 V, and the adsorption bias Vf2 which is determined by the second calculation unit 102 in Act 15, becomes 2400 V (600 V+1800 V).

When performing printing, first, the controller 50 outputs an on-signal, a control signal indicating a level which corresponds to the adsorption bias Vf1 which is determined in Act 8, and a switching signal to the constant voltage, to the adsorption transformer 80. At this time, the adsorption bias Vf1 is applied to the adsorption roller 33 by the voltage and current output unit 81, and the adsorption roller 33 is charged. In this state, the controller 50 rotates the drum 13 and applies the electrostatic charge to the sheet P which passes through the nip formed between the adsorption roller 33 and the drum 13, thereby adsorbing the sheet P onto the outer peripheral surface of the drum 13 using the electrostatic force. Thereafter, the sheet P is conveyed due to the rotation of the drum 13, and the inkjet unit 39 forms an image on the first surface of the sheet P.

When the image formation onto the first surface is completed, the sheet P is reversed using the reversing device 18. At this moment, the controller 50 outputs an on-signal, a control signal which denotes a level which corresponds to the adsorption bias Vf2 which is determined in Act 14, and the switching signal to the constant voltage, to the adsorption transformer 80. In this manner, the adsorption bias Vf2 is applied to the adsorption roller 33 by the voltage and current output unit 81, and the adsorption roller 33 is charged. In this state, the controller 50 rotates the drum 13 and applies the electrostatic charge to the sheet P which passes through the nip formed between the adsorption roller 33 and the drum 13, thereby adsorbing the sheet P onto the outer peripheral surface of the drum 13 using the electrostatic force. Thereafter, the sheet P is conveyed due to the rotation of the drum 13, and the inkjet unit 39 forms an image on the second surface of the sheet P.

When the printing job is printing for plural pages, printing for each page is performed, for example, by obtaining a common adsorption bias Vf1 for each page, obtaining the adsorption bias Vf2 for each page, and using the obtained adsorption bias Vf1 and the adsorption bias Vf2 for each page.

### [Correction of Correction Voltage Table]

Subsequently, as a modified example of the embodiment, an example in which the correction voltage table 110 can be corrected, will be described. In this case, the correction voltage table 110 is stored in a rewritable non-volatile memory in the inkjet recording apparatus 1, in order to realize this function.

The correction voltage table 110 is created, for example, according to the recommended paper by the manufacturer of the inkjet recording apparatus 1. However, since there are various types within “thin paper”, “plain paper”, and “thick paper”, it is not possible for the correction voltage table 110 to exactly correspond to the sheet to be used in the inkjet recording apparatus 1 in practice.

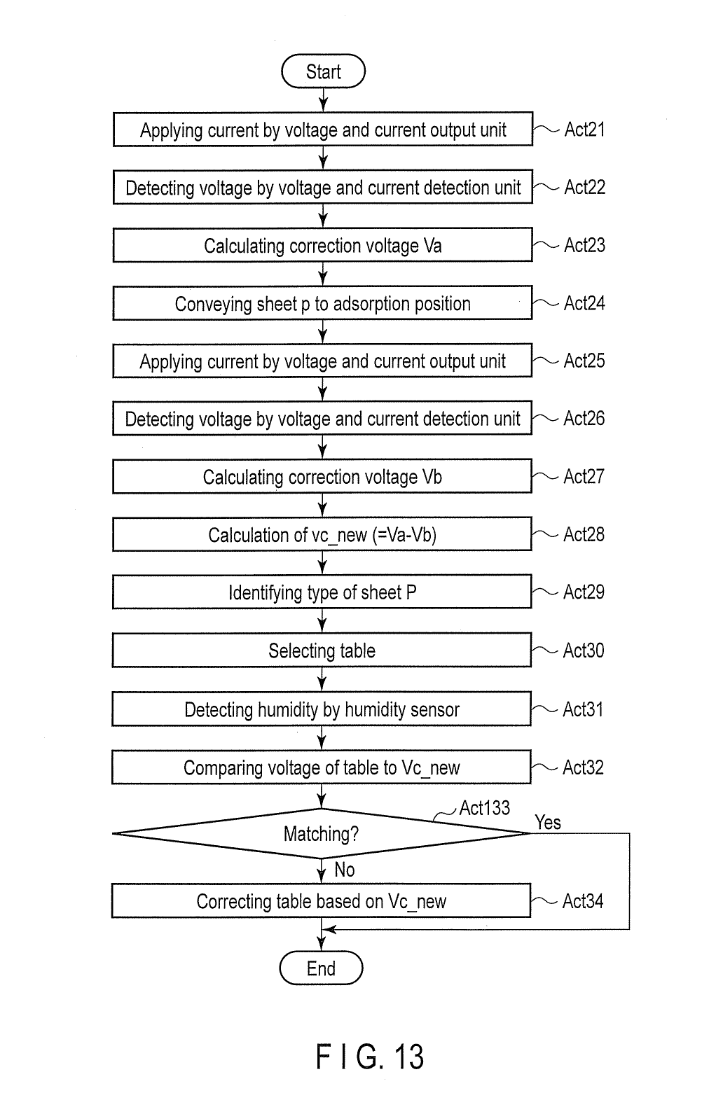

Here, in the embodiment, the correction unit 105 performs operation shown in the flowchart in FIG. 13, and corrects voltage which is defined in the correction voltage table 110 according to the sheet to be used in the inkjet recording apparatus 1 in practice.

In this flowchart, first, the first correction voltage Va is obtained in the same method as those in Acts 1 to 3. That is, the controller 50 outputs an on-signal, a control signal which denotes the predetermined level (30 μA in the embodiment), and the switching signal to the constant current, to the adsorption transformer 80, in a state where the sheet P is not present at the adsorption position X, and the voltage and current output unit 81 which received these signals outputs the constant current of 30 μA to the adsorption roller 33 (Act 21). In addition, the voltage and current detection unit 82 detects voltage which is generated at the adsorption position X (Act 22). At this moment, the controller 50 obtains the monitor voltage Vma on the basis of the monitor signal which is informed from the adsorption transformer 80, and the first calculation unit 101 obtains the first correction voltage Va in which the current which flows when being applied to adsorption roller 33, is supposed to be the predetermined target value, on the basis of the monitor voltage Vma (Act 23).

Subsequently, the controller 50 rotates any one of the pick-up rollers 24a to 24c, the pair of sheet feeding rollers 25, and the pair of resist rollers 26, and conveys the sheet P to the adsorption position (Act 24). Here, the conveyed sheet P may be the preset sheet, or may be a designated sheet by an input from the operation panel 70 or the interface 54. In Act 24, the controller 50 rotates a pick-up roller which corresponds to a sheet feeding cassette in which the preset sheet P, or the designated sheet P in this manner, is accommodated.

In a state where the sheet P is inserted at the adsorption position, the controller 50 outputs an on-signal, a control signal which denotes a predetermined level (30 μA in the embodiment), and a switching signal to the constant current, to the adsorption transformer 80, and the voltage and current output unit 81 which received these signals outputs the constant current of 30 μA to the adsorption roller 33 (Act 25). In addition, the voltage and current detection unit 82 detects voltage which is generated in the voltage and current output unit 81, in other words, generated at the adsorption position X (Act 26). The detected voltage is informed to the controller 50 by the monitor signal. The controller 50 obtains the monitor voltage Vmb on the basis of the monitor signal. Subsequently, the first calculation unit 101 obtains the correction voltage Vb in which the current which flows when being applied to the adsorption roller 33 is supposed to be the predetermined target value, on the basis of the monitor voltage Vmb (Act 27).

When the correction voltages Va and Vb are obtained, the correction unit 105 obtains voltage Vc_new (=Va−Vb) by subtracting the correction voltage Vb from the first correction voltage Va (Act 28).

After obtaining the voltage Vc_new, the medium identifying unit 103 identifies a type of the sheet P at the adsorption position X (Act 29), and the correction unit 105 selects a table which corresponds to the type of the sheet P identified by the medium identifying unit 103 from the tables 110a to 110c which constitutes the correction voltage table 110 (Act 30).

Further, the controller 50 drives the humidity sensor 71 to detect humidity in the inkjet recording apparatus 1 (Act 31).

Thereafter, the correction unit 105 compares the voltage which corresponds to the humidity detected by the humidity sensor 71, in the table which is selected in Act 30, to the voltage Vc_new (Act 32). As a result of the comparison, if both the voltages match each other (Yes, in Act 33), the operation shown in the flowchart ends.

Meanwhile, if both the voltages do not match each other (No, in Act 33), the correction unit 105 corrects the correction voltage table 110, on the basis of the voltage Vc_new (Act 34). In Act 34, the correction unit 105 substitutes the voltage which corresponds to the humidity detected by the humidity sensor 71, in the table which is selected in Act 30, to the voltage Vc_new. In addition to this, each voltage which is defined in each of tables 110a to 110c may be increased or decreased, according to a difference between the voltage which corresponds to the humidity detected by the humidity sensor 71, in the table which is selected in Act 30 and the voltage Vc_new. In this case, for example, the amount of change of each voltage accompanying the variation in humidity, which is defined in each table 110a to 110c, may increase or decrease each voltage so as to match before and after the correction.

After the correction in Act 34, the operation shown in the flowchart ends.

The operation shown in the flowchart as described above in FIG. 13 is executed with respect to the sheet P of each type which is set in the sheet feeding cassettes 11a to 11c, for example, when power is input to the inkjet recording apparatus 1. In addition, the operation shown in the flowchart in FIG. 13 may be executed when users operate the operation panel 70 and input execution instruction, or may be automatically executed with respect to the sheet feeding cassette which is related to an exchange or supplement, when any one of the sheet feeding cassettes 11a to 11c is exchanged or supplemented with the sheet P.

As described above, the inkjet recording apparatus 1 according to the embodiment determines the adsorption bias to be applied to the adsorption roller 33 by the voltage and current output unit 81, on the basis of the humidity which is detected by the humidity sensor 71. In this configuration, it is possible to reliably adsorb the sheet P onto the outer peripheral surface of the drum 13, since a suitable adsorption bias is determined in consideration of the humidity. As a result, it is possible to prevent a position deviation when forming images on the sheet P, or the jamming of the sheet P.

In addition, the inkjet recording apparatus 1 according to the embodiment determines the adsorption bias in consideration of a type of the sheet P to be used in printing as well, in addition to the humidity. Accordingly, it is possible to determine the adsorption bias as a value which is suitable to the type of the sheet P to be used in the printing.

Further, the inkjet recording apparatus 1 according to the embodiment determines the adsorption bias in consideration of the printing rate R of the first surface as well, when performing the double-sided printing. In general, the electrostatic force is weakened when ink attaches to the sheet P (particularly water-based ink). Accordingly, in consideration of the printing rate R of the first surface, it is possible to determine the adsorption bias as a more suitable value.

In addition, the inkjet recording apparatus 1 according to the embodiment calculates the first correction voltage Va on the basis of the voltage which is generated at the adsorption position X in practice, when allowing the constant current to flow in the adsorption roller 33, or the current which is generated at the adsorption position X in practice, when applying the constant voltage to the adsorption roller 33, and the adsorption bias is determined in consideration of the first correction voltage Va. In this manner, it is possible to determine the adsorption bias which absorbs the influence of changes in the resistance value due to deterioration over time of the adsorption roller 33.

In addition, in the inkjet recording apparatus 1 according to the embodiment, the correction unit 105 corrects the voltage which is defined in the correction voltage table 110, on the basis of the actual measurement value. Accordingly, it is possible to set the value of the correction voltage table 110 to a value which corresponds to the sheet P set in the sheet feeding cassette 11, in practice.

### [Modifications]

The configuration which is disclosed in the above described each embodiment can be embodied by appropriately modifying each constituent element in each stage of the execution.

For example, in the above described embodiment, the inkjet recording apparatus 1 which adopted an inkjet-type was exemplified, however the configuration relating to the correction of the adsorption bias may be applied to an image forming apparatus which adopts a printing mechanism such as a heat transfer-type or an electrophotographic-type.

In addition, in the above described embodiment, three types of the sheet P of thin paper, plain paper, and thick paper are exemplified as the type of the sheet P, however, the types of sheet may be increased or decreased according to the number of sheet feeding units such as the sheet feeding cassette, or the like. When the type of the sheet P is changed, the number of tables for each type of the sheet P, which constitutes the correction voltage table 110 may be increased or decreased according to the number of the types of the sheet P.

In addition, in the above described embodiment, the second correction voltage Vc corresponding to the type of the sheet P or the humidity, was obtained using the correction voltage table 110. However, the second correction voltage Vc may be obtained in such a manner that a calculation formula for calculating the second correction voltage Vc is stored in the ROM 52 or the RAM 53 by setting the humidity or the type of the sheet P as the parameter, and the calculation formula is used, instead of the correction voltage table 110.

Further, in the above described embodiment, the adsorption bias was obtained in consideration of the humidity, the type of the sheet P, the printing rate R to the first surface, and the voltage or the current which is generated at the adsorption position X when the sheet P is not present. However, the adsorption bias may be obtained by using any one of these elements, or plural elements, without using all of these elements.

In addition, the order of each operation shown in FIGS. 9, 11, 13, and the like, may be appropriately shifted.

Further, in the above described embodiment, a case where the second correction voltage Vc was obtained using a relative humidity which is detected by the humidity sensor 71, was exemplified. However, it is possible to obtain the second correction voltage Vc, by allowing the humidity sensor 71 to detect the absolute humidity and using the absolute humidity. In this case, it is possible to obtain the second correction voltage Vc in such a manner that, for example, the correction voltage table 110 is provided for each temperature, a temperature sensor is also provided in the humidity sensor 71, the correction voltage table 110 which corresponds to the temperature detected in the temperature sensor, is selected, thereby using the selected correction voltage table 110.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a conveying mechanism which adsorbs and conveys a recording medium using an electrostatic force;
a printing head which forms an image on the recording medium which is conveyed by the conveying mechanism;
a charging device which performs charging according to applied voltage, and allows the recording medium to be absorbed to the conveying mechanism using the electrostatic force;
a humidity sensor which detects a humidity in the apparatus; and
a controller which determines voltage which is applied to the charging device for charging the charging device, on the basis of at least the humidity which is detected by the humidity sensor.

2. The image forming apparatus of claim 1,
wherein the controller determines the voltage which is applied to the charging device, on the basis of the humidity detected by the humidity sensor and a type of the recording medium.

3. The image forming apparatus of claim 1, further comprising:
a reversing mechanism which reverses the front and rear surfaces of the recording medium which is conveyed by the conveying mechanism,
wherein the controller determines the voltage to be applied to the charging device for adsorbing the recording medium which is reversed by the reversing mechanism, to the conveying mechanism, on the basis of the humidity which is detected by the humidity sensor, and a printing rate of a first surface of the recording medium, when conveying the recording medium which is reversed using the reversing mechanism by the conveying mechanism, after forming the image on the first surface of the recording medium which is conveyed using the conveying mechanism.

4. The image forming apparatus of claim 3,
wherein the printing head is an inkjet head which forms an image by ejecting water-based ink to the recording medium which is conveyed by the conveying mechanism.

5. The image forming apparatus of claim 1, further comprising:
a charging control circuit which detects voltage or current which is generated at a position where the charging device applies the electrostatic force to the conveying mechanism or recording medium,
wherein the controller determines the voltage to be applied to the charging device, on the basis of the voltage which is detected by the charging control circuit when allowing current of a predetermined value to flow in the charging device, in a state where the recording medium is not present at the position, or the current which is detected by the charging control circuit, when a predetermined value of voltage is applied to the charging device, in a state where the recording medium is not present at the position, and the humidity which is detected by the humidity sensor.

6. The image forming apparatus of claim 5,
wherein the controller obtains a first correction voltage in which the current which flows at the position when being applied to the charging device becomes the predetermined target value, on the basis of the voltage or the current which is detected by the charging control circuit, and obtains a second correction voltage which corresponds to the humidity which is detected by the humidity sensor, thereby determining a value in which the first correction voltage and the second correction voltage are added, as the voltage to be applied to the charging device.

7. The image forming apparatus of claim 6,
wherein the controller sets voltage which is defined in a table in which the voltage is defined for each humidity with respect to the humidity detected by the humidity sensor, as the second correction voltage.

8. The image forming apparatus of claim 7,
wherein the controller obtains voltage in which current which flows when being applied to the charging device becomes the target value, on the basis of the voltage which is detected by the charging control circuit when the predetermined value of current is caused to flow in the charging device, or current which is detected by the charging control circuit when applying the predetermined value of voltage to the charging device, for both the state where the recording medium is not present at the position and the state where the recording medium is present, thereby correcting the voltage which is determined in the table, on the basis of a difference value of the obtained each voltage.

9. The image forming apparatus of claim 8,
wherein the controller substitutes the voltage which is defined in the table with respect to the humidity which is detected by the humidity sensor with corrected voltage on the basis of the difference value.

10. The image forming apparatus of claim 7, further comprising:
a reversing mechanism which reverses the front and rear surfaces of the recording mechanism which is conveyed by the conveying mechanism,
wherein the controller sets a value in which the voltage which is defined in the table with respect to the humidity detected by the humidity sensor, is increased or decreased according to a printing rate of a first surface of the recording medium, to the second correction voltage, when conveying the recording medium which is reversed by the reversing mechanism using the conveying mechanism, after forming images on the first surface of the recording medium which is conveyed by the conveying mechanism, thereby determining the voltage to be applied to the charging device, in order to adsorb the recording medium which is reversed by the reversing mechanism to the conveying mechanism.

11. The image forming apparatus of claim 10,
wherein the printing head is the inkjet head which forms an image by ejecting water-based ink to the recording medium which is conveyed by the conveying mechanism.

12. The image forming apparatus of claim 6, further comprising:
a table in which voltage is defined with respect to a combination of the humidity and the type of the recording medium, in the controller,
wherein the controller set the voltage which is defined in the table with respect to the combination of the humidity detected by the humidity sensor and the type of the recording medium, to the second correction voltage.

13. A recording medium conveying apparatus comprising:
a conveying mechanism which adsorbs and conveys a recording medium using an electrostatic force;
a charging device which performs charging according to applied voltage, and allows the recording medium to be absorbed to the conveying mechanism using the electrostatic force;
a humidity sensor which detects humidity in the apparatus; and
a controller which determines voltage which is applied to the charging device for charging the charging device, on the basis of at least the humidity which is detected by the humidity sensor.

14. The recording medium conveying apparatus of claim 13,
wherein the controller determines voltage to be applied to the charging device, on the basis of humidity which is detected by the humidity sensor and a type of the recording medium.

15. The recording medium conveying apparatus of claim 13, further comprising:
a reversing mechanism which reverses the front and rear surfaces of the recording medium which is conveyed by the conveying mechanism,
wherein the controller determines the voltage to be applied to the charging device for adsorbing the recording medium which is reversed by the reversing mechanism, to the conveying mechanism, on the basis of the humidity which is detected by the humidity sensor, and a printing rate of a first surface of the recording medium.

16. The recording medium conveying apparatus of claim 13, further comprising:
a charging control circuit which detects voltage or current which is generated at a position where the charging device applies the electrostatic force to the conveying mechanism or recording medium,
wherein the controller determines the voltage to be applied to the charging device, on the basis of the voltage which is detected by the charging control circuit when allowing current of a predetermined value to flow in the charging device, in a state where the recording medium is not present at the position, or the current which is detected by the charging control circuit, when a predetermined value of voltage is applied to the charging device, in a state where the recording medium is not present at the position, and the humidity which is detected by the humidity sensor.

17. An image forming method comprising:
detecting humidity using a humidity sensor;
determining voltage to be applied to a charging device on the basis of at least the humidity which is detected by the humidity sensor;
charging the charging device by applying the determined voltage to the charging device, and adsorbing a recording medium to a conveying mechanism using an electrostatic force;
conveying the recording medium which is adsorbed to the conveying mechanism; and
forming an image using an printing head on the recording medium which is conveyed by the conveying mechanism.

18. The image forming method of claim 17, wherein the printing head ejects water-based ink.
